(19) United States
(12) Patent Application Publication
(10) Pub. No.: US 2025/0369543 A1
(43) Pub. Date: Dec. 4, 2025

(54) FLEXIBLE PIPE CONNECTOR AND MANUFACTURING METHOD THEREFOR

(71) Applicant: DONG-A FLEXIBLE METAL TUBES CO., LTD., YONGIN-SI (KR)

(72) Inventor: Jinrim CHOI, YONGIN-SI (KR)

(73) Assignee: DONG-A FLEXIBLE METAL TUBES CO., LTD., YONGIN-SI (KR)

(21) Appl. No.: 19/225,017

(22) Filed: Jun. 2, 2025

(30) Foreign Application Priority Data
Jun. 3, 2024 (KR) 10-2024-0072294
Mar. 18, 2025 (KR) 10-2025-0034527

(51) Int. Cl. F16L 27/111; B23K 1/008; B23K 101/06; B23K 103/04

(52) U.S. Cl. CPC F16L 27/111; B23K 1/008; B23K 2101/06; B23K 2103/05

(57) ABSTRACT

A flexible pipe connector according to an embodiment of the present invention includes a corrugated pipe, an end ring inserted into and welded to an end portion of the corrugated pipe, a circular ring disposed on the outer side of the end portion of the corrugated pipe, a braided net that covers a portion of an outer circumferential surface of the end ring, an outer circumferential surface of the corrugated pipe, and an outer circumferential surface of the circular ring, and a welding ring inserted into the end ring so thin the end portion of the corrugated pipe is disposed in a gap formed between the welding ring and the end ring, the end portion of the corrugated pipe being welded, in order to simplify a welding structure of the flexible pipe connector to which a fluid transport pipe is connected, improve welding quality, and minimize damage from friction due to vibration, thereby improving the reliability of a product and extending the life thereof.

### BACKGROUND OF THE INVENTION

### 1. Field of the Invention

The present invention relates to a flexible pipe connector to which a fluid transport pipe is connected, and more specifically, to a flexible pipe connector and a manufacturing method therefor which prevent a corrugated pipe made of a metal from be cracked or ruptured and absorb vibration by covering the corrugated pipe with a braided net woven with steel wires.

### 2. Description of the Related Art

In a case in which a pipe or a connector therefor is likely to be bent during use or due to the narrowness of an installation place when a fluid transport pipe is connected to a predetermined device or fluid transport pipes are connected to each other, a flexible pipe connector having a predetermined flexibility with no concern of rupturing or damage even when the pipe or the connector therefor is bent is used.

For example, a flexible pipe connector is used for piping for supplying a high-pressure fluid such as a refrigerant for an air conditioner, a combustion gas for a heating device, or a liquid for fire extinguishing.

The flexible pipe connector described above includes a corrugated pipe having a plurality of alternately formed roots and crests through which a fluid passes, and a braided mesh woven with stainless steel wires, which covers the corrugated pipe to prevent the corrugated pipe from being stretched or ruptured.

However, the related art has a problem that incomplete welding occurs between the braided mesh and a base metal of a welded portion, a welding structure is complicated, and the numbers of welding processes and components increase, leading to higher manufacturing costs and longer manufacturing time for the flexible pipe connector.

Further, the related art has problems that components collide with each other during vibration, causing damage to the components, and that, when a hardness of a corrugated pipe falls below or exceeds a predetermined range, the corrugated pipe is bent or ruptured due to failing to absorb the vibrations.

In particular, when a flexible pipe connector is installed in a device in which vibration occurs continuously, an end portion of a metal corrugated pipe and a braided mesh covering the end portion of the corrugated pipe are severely abraded due to vibration, causing a crack in the end portion of the corrugated pipe, resulting in a problem that a refrigerant passing through the corrugated pipe leaks to the outside.

Further, in the related art, a flexible pipe connector in which components are welded using a gas silver brazing scheme has not only inconvenience of having to perform welding work on components to be welded together for each welded portion, but also a problem that a surface oxidation phenomenon and welding stress occur in a weld bead portion and surroundings thereof during welding work, and grain boundary carbide precipitation and stress corrosion cracking gradually occur over time in the welded portion, making the connector vulnerable.

Meanwhile, in the corrugated pipe that transports a fluid, a phenomenon that vibration of a compressor that compresses a refrigerant gas is transmitted to a piping line of a closed circuit may occur. Specifically, stress corrosion occurs and hardness becomes 240 Hv or more due to welding stress (welding stress of a thin-walled straight pipe) and corrugation processing stress (martensite structure formation) generated in a manufacturing process for a corrugated pipe, resulting in insufficient bending flexibility of the corrugated pipe and insufficient vibration absorption in a short corrugated pipe so that vibration is transmitted to the piping line of the closed circuit and the purpose of use of the flexible pipe connector is lost.

In order to solve the above problem, a corrugated pipe with improved elasticity and vibration absorption can be obtained by adding an annealing heat treatment process to a manufacturing process.

However, welding stress and processing stress can be removed through a manufacturing process further including the annealing heat treatment process in the related art, but since the flexibility of the corrugated pipe increases, a bending phenomenon according to a vibration amplitude occurs in the corrugated pipe side adjacent to a compressor (or pump) in which vibration occurs, this phenomenon is accumulated as much as a frequency, and processing stress is generated locally and intensively in a bent portion and accumulated, resulting in a fatal problem of occurrence of crack and corrosion.

### SUMMARY OF THE INVENTION

An object of the present invention is to solve various problems of the related art above described.

Another object of the present invention is to provide a flexible pipe connector and a manufacturing method therefor that allow a welding structure of a flexible pipe connector to be simplified, improve welding quality, and reduce production costs.

Still another object of the present invention is to provide a flexible pipe connector and a manufacturing method therefor that allow a corrugated pipe and an end ring to be closely coupled.

Still another object of the present invention is to provide a flexible pipe connector and a manufacturing method therefor capable of preventing a corrugated pipe from being cracked by reducing friction between the corrugated pipe and a braided net covering the corrugated pipe even when large and small vibrations continuously occur, to prevent the corrugated pipe and the braided net from being damaged even during long-term use, thereby improving the reliability of a product and extending the life of the product.

Still another object of the present invention is to provide a flexible pipe connector and a manufacturing method therefor capable of improving work efficiency by allowing a welding ring to be easily inserted into an end portion of a braided mesh.

Still another object of the present invention is to provide a flexible pipe connector and a manufacturing method therefor that allow brazing welding between components to be simultaneously performed by performing a single heating process in a heat treatment furnace, and allow a processing hardening heat treatment work to remove stress generated during welding or metal processing.

Still another object of the present invention is to provide an annealing heat treatment hardness for removing welding stress and processing hardening generated in a manufacturing method for a corrugated pipe and increasing spring elasticity of the corrugated pipe, since a corrugated pipe produced through a manufacturing process including an annealing heat treatment process of the related art is not suitable as a corrugated pipe for vibration absorption due to excessive flexibility with Vickers hardness being 160 HV to 170 HV and low spring elasticity.

The objects of the present disclosure are not limited to the objects mentioned above, and other objects that are not mentioned can be clearly understood by those skilled in the art from the description below.

According to an aspect of the present invention for achieving the above object, a flexible pipe connector includes a corrugated pipe, an end ring having one side portion inserted into and welded to an end portion of the corrugated pipe; a braided net woven with steel wires covering a portion of an outer circumferential surface of the end ring and an outer circumferential surface of the corrugated pipe; and a welding ring having an expanded pipe portion formed in one side portion, and inserted into the end ring so that an end portion of the braided net is disposed in a gap between the expanded pipe portion and the end ring, the end portion of the braided net being welded to the welding ring.

Meanwhile, according to an aspect of the present invention for achieving the above object, a method for manufacturing a flexible pipe connector includes applying a welding agent to an end portion of a corrugated pipe and inserting one side portion of an end ring into the end portion; covering a portion of an outer circumferential surface of the end ring and the corrugated pipe with a braided net, a welding agent being applied to an end portion of the braided net; inserting a welding ring into the end ring so that an expanded pipe portion of the welding ring covers the end portion of the braided mesh; and heating an assembly of the corrugated pipe, the end ring, the braided mesh, and the welding ring in a heat treatment furnace to melt the welding agent and then performing cooling.

According to an aspect of the present invention for achieving the above object, a flexible pipe connector includes a corrugated pipe, an end ring having one side portion inserted into and welded to an end portion of the corrugated pipe; a circular ring disposed on the end portion of the corrugated pipe; a braided net woven with steel wires covering a portion of an outer circumferential surface of the end ring, an outer circumferential surface of the corrugated pipe, and an outer circumferential surface of the circular ring; and a welding ring inserted into an outer side of the end ring, an end portion of the braided net being inserted into a gap between the welding ring and the end ring and welded.

The circular ring is disposed to protrude outward from the corrugated pipe beyond a crest of the corrugated pipe.

The circular ring may be partially inserted into a root between a crest at an extreme end formed in a one side end portion of the corrugated pipe and a crest adjacent to the crest at the extreme end, that is, a root formed at an extreme end among roots of the corrugated pipe.

The circular ring may be disposed between the crest at the extreme end of the corrugated pipe and the welding ring.

The circular ring may be a spring ring with one cut side.

The welding ring may have an expanded pipe portion formed in one side portion, and the end portion of the braided mesh may be inserted into the gap between the expanded pipe portion and the end ring and welded.

Further, the end ring may have a step portion formed in an one side portion having a smaller outer diameter than the other side portion, the step portion of the end ring and the end portion of the corrugated pipe may be welded, a shoulder portion may be formed between the other side portion of the end ring and the step portion, an vertical extension portion may be formed at an extreme end in the end portion of the corrugated pipe, and the shoulder portion of the end ring and the vertical extension portion of the corrugated pipe may be welded.

Further, the end portion of the braided mesh may be bonded to the outer circumferential surface of the end ring with an instant adhesive. Further, the end portion of the braided mesh may be temporarily bonded to the outer circumferential surface of the end ring with an instant adhesive.

Further, a front end portion of the expanded pipe portion of the welding ring may be formed as an inclined surface whose inner diameter gradually decreases inward.

Meanwhile, according to an aspect of the present invention for achieving the above object, a method for manufacturing a flexible pipe connector includes applying a welding agent to an end portion of a corrugated pipe and inserting one side portion of an end ring into the end portion; disposing a protective ring in the end portion of the corrugated pipe before or after the applying; covering a portion of an outer circumferential surface of the end ring, the corrugated pipe, and the protective ring with a braided net, a welding agent being applied to an end portion of the braided net; inserting a welding ring into the end ring so that an expanded pipe portion of the welding ring covers the end portion of the braided mesh; and heating an assembly of the corrugated pipe, the circular ring, the end ring, the braided mesh, and the welding ring in a heat treatment furnace to melt the welding agent and then performing cooling.

The method may include, after the step is completed, putting an assembly of the corrugated pipe, the end ring, the braided net, and the welding ring into a heat treatment furnace to heat the assembly so that the welding agent is melted, and then performing cooling.

Further, the step portion of the end ring may be inserted into the end portion of the corrugated pipe in a forced fit manner. The welding ring may be fitted and welded to an outer side portion of the end ring.

Further, in the welding ring, the end portion of the braided mesh may be inserted into an inner circumferential surface of the expanded pipe portion having a larger outer diameter than the other side portion. The expanded pipe portion of the welding ring, an outer diameter portion of the end ring, and the end portion of the braided mesh may be welded.

Further, the shoulder portion formed between the step portion of the end ring and the other side portion may be inserted into an extreme end of the corrugated pipe and welded.

Further, the welding ring may be processed so that a portion covering the end portion of the braided mesh is formed as an expanded pipe portion, and an inner circumferential surface of a front end portion of the expanded pipe portion is formed as an inclined surface.

Further, the method may include temporarily bonding the end portion of the braided mesh to the outer circumferential surface of the end ring with an instant adhesive for a metal before the welding ring is inserted into the end ring.

Further, the expanded pipe portion of the welding ring may be formed to have a relatively large inner diameter, the end portion of the braided mesh may be inserted into the expanded pipe portion, and then the expanded pipe portion may be compressed to minimize a welding gap between the expanded pipe portion and the end portion of the braided mesh.

Further, a plate-shaped ring, a circular ring, or an oval ring may be inserted between the corrugated pipe and the braided mesh to prevent cracks in a top portion of the crest of the corrugated pipe due to friction caused by vibration in an outer side portion (the top portion of the crest) of the corrugated pipe and the braided mesh.

Further, the flexible pipe connector according to the present disclosure may be heated at 1050° C. to 1150° C. in a heat treatment furnace for a predetermined time and then cooled so that component welding, corrugated pipe processing, and stress relief processes can be completed simultaneously.

Specific details of other embodiments are included in the detailed description and drawings.

The flexible pipe connector and a manufacturing method therefor according to the embodiment of the present invention have one or more of the following effects.

First, in the flexible pipe connector according to the embodiment of the present invention, since the corrugated pipe is covered by the braided net in a state in which the circular ring protruding outward beyond the crest of the corrugated pipe is disposed in the end portion of the corrugated pipe or the plate-shaped ring is disposed on the outer side beyond the crest of the corrugated pipe, the problem that a top portion of the crest of the corrugated pipe is worn and damaged (for example, holed or cracked) due to friction between the adjacent braided net and corrugated pipe is prevented even in an environment in which continuous vibration occurs for a long time.

Second, in the flexible pipe connector according to the embodiment of the present invention, since the step portion and the shoulder portion are formed on the outer circumferential surface of the end ring, and the end of the corrugated pipe and the shoulder portion are welded in a state in which the end of the corrugated pipe is in contact with the shoulder portion, a coupled state of the end ring and the corrugated pipe is securely maintained even when vibration or shock occurs for a long time.

Third, since an inner circumferential surface of a front end portion of the welding ring is formed as an inclined surface, and a right angle portion of the front end portion of the welding ring that comes into contact with the braided mesh is eliminated, not only can the end portion of the braided mesh be easily inserted along the inclined surface of the expanded welding ring, but also, the braided mesh is prevented from being damaged, ruptured, or cracked due to friction with a top portion of the outer crest of the corrugated pipe even when vibration, impact, or bending occurs for a long time since the inner circumferential surface of the front end portion of the welding ring that comes into contact with the braided mesh is formed as the inclined surface rather than a right-angled surface.

Fourth, since the end portion of the braided mesh is bonded to the end ring and then inserted into the welding ring, steel wires located in the end portion of the braided mesh can be neatly aligned and easily inserted into the welding ring.

Fifth, since the flexible pipe connector according to the present disclosure in which components are assembled is heated to a melting temperature of the welding agent within an annealing temperature range for stress relief of the corrugated pipe in a heat treatment furnace, a heat treatment process for relieving the processing stress and welding stress of the corrugated pipe and a welding process can be easily performed simultaneously.

The effects of the present disclosure are not limited to the effects mentioned above, and other effects that are not mentioned can be clearly understood by those skilled in the art from the description of the claims.

### BRIEF DESCRIPTION OF THE DRAWINGS

FIG. 1 is a front view of a flexible pipe connector illustrating a partially cut state according to a first embodiment of the present disclosure.

FIGS. 2 and 3 are a perspective view and a cross-sectional view of an end ring.

FIGS. 4 and 5 are a perspective view and a cross-sectional view of a welding ring.

FIGS. 6 to 9 are cross-sectional views showing manufacturing steps of the flexible pipe connector according to the first embodiment of the present disclosure.

FIG. 10 is a cross-sectional view illustrating a second embodiment of the present disclosure.

FIG. 11 is a front view of a flexible pipe connector illustrating a partially cut state according to a third embodiment of the present disclosure.

FIG. 12 is a perspective view of a circular ring included in a flexible pipe connector according to the third to fifth embodiments of the present disclosure.

FIGS. 13 to 16 are cross-sectional views showing manufacturing steps of the flexible pipe connector according to the third embodiment of the present disclosure.

FIG. 17 is a cross-sectional view illustrating a fourth embodiment of the present disclosure.

FIG. 18 is a cross-sectional view illustrating a fifth embodiment of the present disclosure.

FIG. 19 is a partially cut perspective view of a plate-shaped ring included in a flexible pipe connector according to sixth and seventh embodiments of the present disclosure.

FIGS. 20 to 23 are cross-sectional views illustrating manufacturing steps of the flexible pipe connector according to the sixth embodiment of the present disclosure.

FIG. 24 is a cross-sectional view illustrating a seventh embodiment of the present disclosure.

### DETAILED DESCRIPTION OF THE PREFERRED EMBODIMENTS

The advantages and features of the present invention and methods for achieving the advantages and features will become clear by referencing the embodiments that will be described in detail later together with the accompanying drawings. However, the present invention is not limited to the embodiments that will be disclosed below, but may be implemented in various different forms, the embodiments are provided only to make the disclosure of the present invention complete and to fully inform those skilled in the art to which the present invention belongs of the scope of the invention, and the present invention is defined only by the claims. The same reference signs refer to the same components throughout the specification.

When one portion is said to be “on” or “above” another portion throughout the specification, this includes not only a case in which the one portion is “directly over” the other portion, but also a case in which there is another portion in between. On the other hand, when a portion is said to be “directly over” another portion, this means that there is no other portion in between.

Further, terms such as “under,” “below,” “on,” and “above” are used to describe an association between components illustrated in the drawings. The terms are relative concepts and are described based on directions indicated in the drawings.

When a component is said to be “connected” or “coupled” to another component, it should be understood that the component may be directly connected or coupled to the other component, or there may be other components disposed in between. On the other hand, when a component is said to be “directly connected” or “directly coupled” to another component, it should be understood that there are no other components disposed in between.

It should be understood that, in the present application, terms such as “include” and “have” are intended to designate the presence of a feature, number, step, operation, component, part, or combination thereof described in the specification, but do not preclude the possibility of the presence or addition of one or more other features, numbers, steps, operations, components, parts, or combinations thereof.

A singular expression includes a plural expression unless the context clearly indicates otherwise.

Hereinafter, a flexible pipe connector according to a first embodiment of the present disclosure will be described with reference to FIGS. 1 to 9.

Referring to FIG. 1, a flexible pipe connector according to an embodiment of the present invention includes a corrugated pipe 10 in which a plurality of crests and roots are formed alternately, an end ring 20 coupled to at least one of both ends of the corrugated pipe 10, a braided mesh 30 covering an outer circumferential surface of the corrugated pipe 10 and a portion of the outer circumferential surface of the end ring 20, and a welding ring 40 inserted into the end ring 20 to cover a portion of the outer circumferential surface of the end ring 20 and an end portion of the braided mesh.

The corrugated pipe 10 may be made of STS 304 and STS 316L, which belong to austenitic stainless steel. The STS 304 contains C at 0.08% or less, Si at 0.5 to 0.75%, P at 0.035% or less, Ni at 8.00 to 15.00%, and Cr at 17.00 to 18.00%, the STS 316L is a stainless steel containing C at 0.03% or less, Si at 0.5 to 0.75%, P at 0.035% or less, S at 0.03% or less, Ni at 12.00 to 15.00%, Cr at 17.00 to 18.00%, and Mo at 2.00 to 3.00%, and a temperature range of solution heat treatment for stress relief of the STS 304 and STS 316L is 1065° C. to 1120° C. Meanwhile, it is preferable that the corrugated pipe be made of a material having a Vickers hardness (HV) of 175 to 200. For example, the corrugated pipe 10 may have a Vickers hardness (HV) in a range of 175 to 185.

The braided net 30, the end ring 20, and the welding ring 40 may also be made of the same material as the corrugated pipe 10.

Further, the corrugated pipe 10 may be manufactured so that a vertical extension portion 12 is formed to extend in a crest (upper) direction from the root of the corrugated pipe 10 located at an extreme end in the end portion of the corrugated pipe 10 or extend in a root (lower) direction from the crest of the corrugated pipe 10 located at the extreme end.

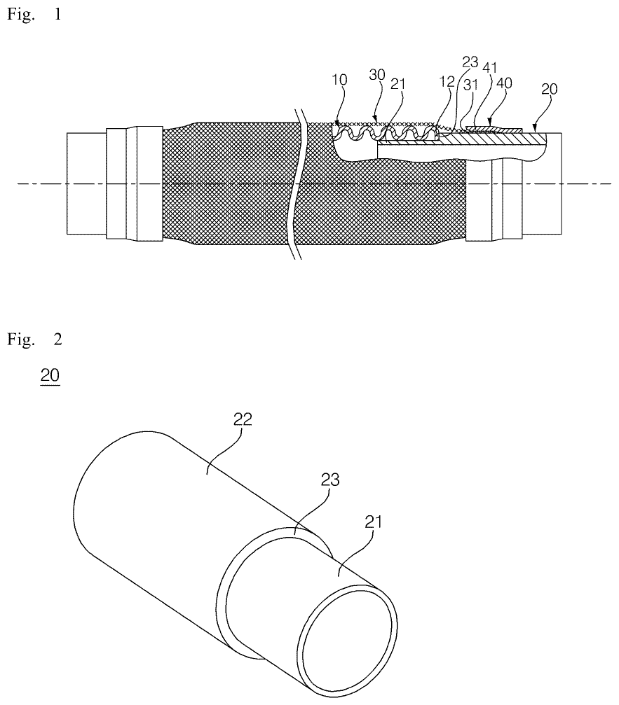

Referring to FIGS. 2 and 3, the end ring 20 is formed in a cylindrical shape, and a step portion 21 is formed so that an outer circumferential surface of one side portion 21 is provided inward toward a central axis X of the end ring 20 beyond an outer circumferential surface of the other side portion 22, and a shoulder portion 23 which is a ring-shaped vertical surface extending in an up and down direction is formed between the step portion 21 and the other side portion 22 of the end ring 20.

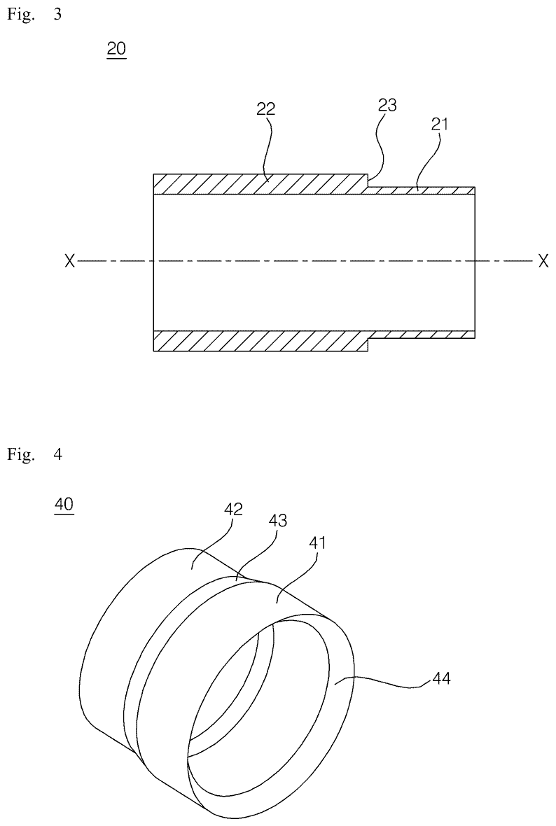

Referring to FIGS. 4 and 5, the welding ring 40 is formed in a cylindrical shape with a stepped central portion 43, one side portion 41 is formed as an expanded pipe portion 41 with a larger inner diameter than the other side portion 42, and an inner circumferential surface 44 at an end portion of the expanded pipe portion 41 is formed as an inclined surface whose inner diameter decreases inward (toward the central portion 43).

The inclined surface may be formed so that a cross-section is inclined in a straight line, or may be formed so that the cross-section is inclined in a curved manner.

Meanwhile, the welding ring 40 is formed to have a lateral length shorter than the end ring 20, so that both end portions of the end ring are exposed to the outer side of the welding ring 40 when the welding ring 40 is inserted into the end ring 20.

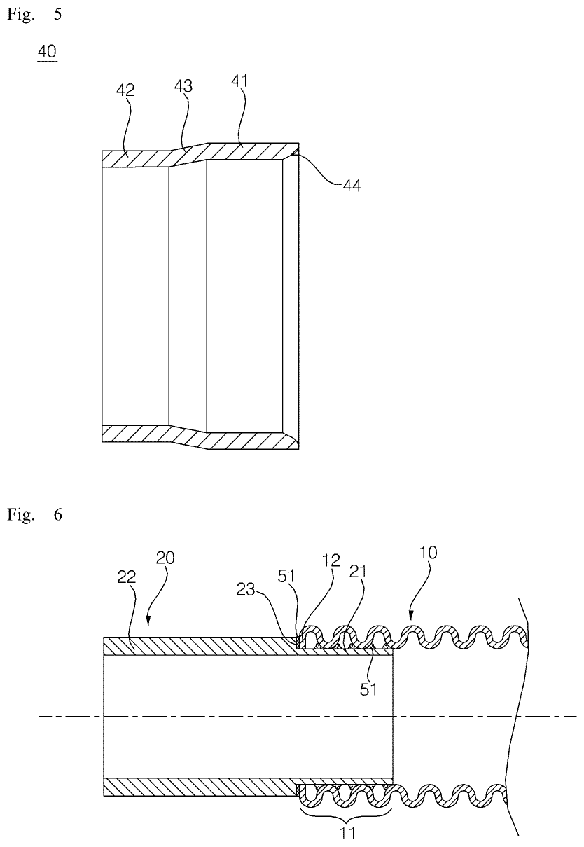

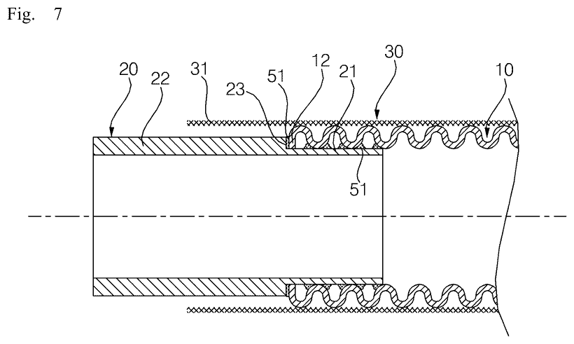

A method for manufacturing a flexible pipe connector according to an embodiment of the present invention configured as described above will be described with reference to FIGS. 6 to 9.

As illustrated in FIG. 6, the step portion 21 formed to have a smaller outer diameter than the other side portion 22 of the end ring 20 is forcibly inserted into the end portion of the corrugated pipe 10, so that the vertical extension portion 12 located at the end of the corrugated pipe 10 is adjacent to the shoulder portion 23 of the end ring 20.

In the above, a paste welding agent 51 is applied to an inner circumferential surface in the end portion 11 of the corrugated pipe 10 and the vertical extension portion 12 so thin the end portion 11 of the corrugated pipe 10, the vertical extension portion 12, and the step portion 21 and the shoulder portion 23 of the end ring 20 can be welded later, and then the step portion 21 of the end ring 20 is forcibly inserted into the end portion of the corrugated pipe 10.

Therefore, since the vertical extension portion 12 formed at the end of the corrugated pipe 10 and the shoulder portion 23 of the end ring 20 are welded in a state in which the vertical extension portion 12 is engaged with the shoulder portion 23 of the end ring 20, the end ring 20 and the corrugated pipe 10 remain securely coupled without any loosening even when vibration or shock occurs during a long time.

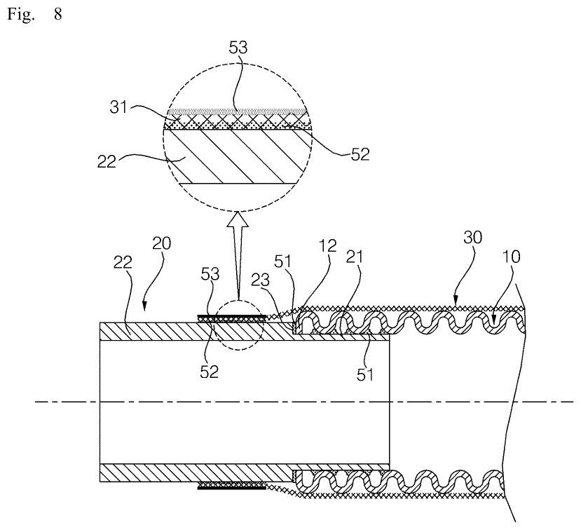

Then, as illustrated in FIG. 7, the outer circumferential surface of the corrugated pipe 10 is covered with the braided net 30 so thin the end portion 31 of the braided net 30 is disposed on the outer circumferential surface of the other side portion 22 of the end ring 20, and as illustrated in FIG. 8, the end portion 31 of the braided net 30 is bonded to the outer circumferential surface of the end ring 20 using an instant adhesive 52 for a metal, and a paste welding agent 53 is applied to the end portion of the braided net 30.

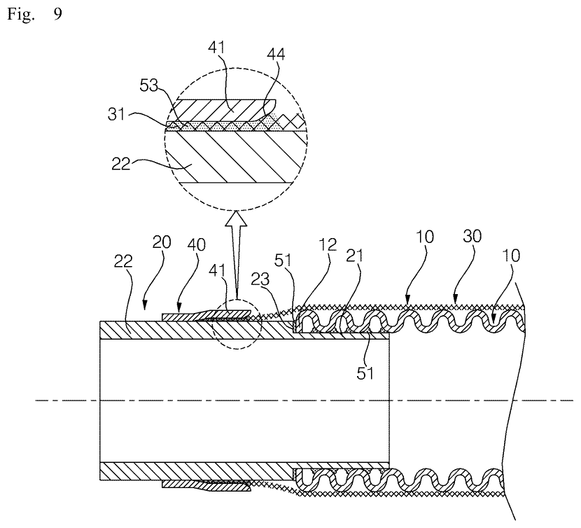

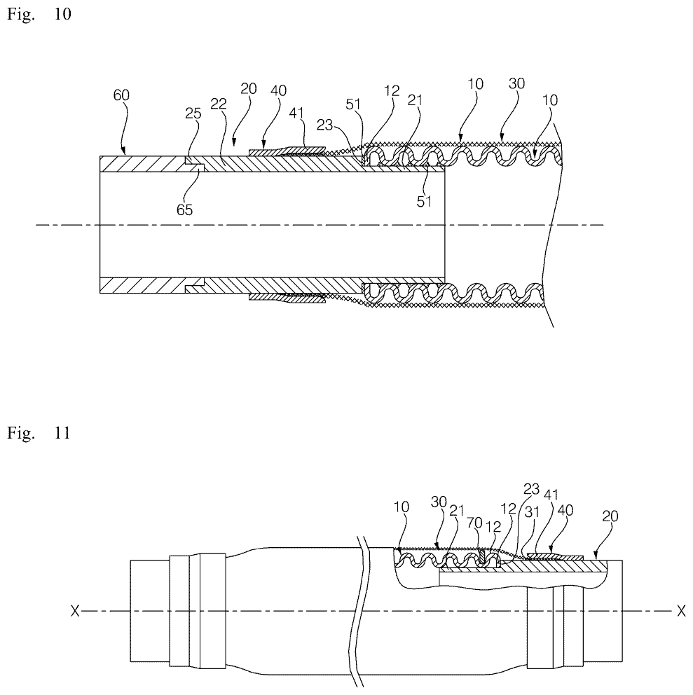

Next, as illustrated in FIG. 9, the welding ring 40 is forcibly inserted into the other side portion 22 of the end ring 20, so thin the end portion 31 of the braided net 30 is disposed in a gap formed between the inner circumferential surface of the expanded pipe portion 41 of the welding ring 40 and the outer circumferential surface of the end ring 20.

In the above, since the end portion 31 of the braided net 30 is bonded to the end ring 20 using an instant adhesive before the welding ring 40 is inserted into the end ring 20, the end portion of the braided net 30, particularly the fine steel wire of the braided net located at the end is bonded to the end ring 20 without bulging, so that a front end portion of the welding ring 40 can be easily inserted to a predetermined position of the end ring 20 without being caught by the steel wires of the braided net 30, and since an inner circumferential surface at the front end portion of the welding ring 40 is formed as an inclined surface 44, the end portion of the braided net 30 can be smoothly moved to a predetermined position of the welding ring 40.

Further, since inner circumferential surface at the front end portion of the welding ring 40 is formed as an inclined surface until the front end portion is inserted into the expanded pipe portion 41 of the welding ring 40, the end portion of the braided net 30 does not come into linear contact with the front end portion of the welding ring 40 but comes into oblique contact with the front end portion even when vibration or shock occurs for a long time, thereby preventing the end portion of the braided net from being damaged or cut.

As described above, when the corrugated pipe 10, the end ring 20, the braided net 30, and the welding ring 40 are placed and heated in a heat treatment furnace and then cooled in a state in which the corrugated pipe 10, the end ring 20, the braided net 30, and the welding ring 40 are coupled, the welding agent applied to the end portion of the corrugated pipe 10 and the end portion of the braided net 30 is melted and then solidified, so that the corrugated pipe 10, the braided net 30, the end ring 20, and the welding ring 40 are securely welded together and integrated.

As the paste welding agent 51 or 53, an Ag—Mn-based welding agent having a welding temperature of 970° C. to 1150° C., an Ag—Cu-based welding agent having a welding temperature of 990° C. to 1090° C., or a Ni—Cr-based welding agent having a welding temperature of 1090° C. to 1180° C., particularly a BniCr-based welding agent containing Ni at 65 to 75 wt %, Cr at 13 to 20 wt %, B at 2.75 to 4.75 wt %, and trace amounts of Fe, Si, and C may be used.

Therefore, when the flexible pipe connector coupled as illustrated in FIG. 9 is placed in a heat treatment furnace and heated at a temperature of 1050° C. to 1150° C., which is a melting temperature of the welding agent 51 or 53, for several seconds, the welding agent 51 or 53 is melted to permeate a welded portion, stress and processing hardening that occur during the molding of the components such as the corrugated pipe 10 are removed, the instant adhesive disappears, and when this is cooled, the welding is completed, thereby completing the manufacture of the flexible pipe connector according to the present disclosure.

As described above, in the flexible pipe connector according to the present disclosure, the components can be easily and closely coupled to each other, there is no concern that the components will loosen or be damaged due to vibration, and the flexible pipe connector can be easily and quickly manufactured due to simultaneous execution of the welding process and the heat treatment process through a single heating process in the heat treatment furnace.

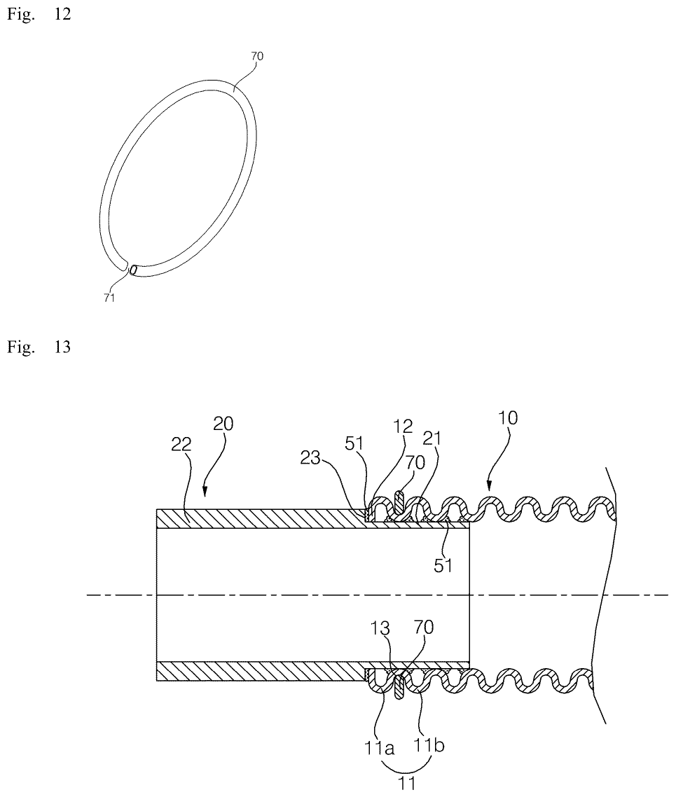

FIG. 10 is a cross-sectional view illustrating another embodiment of the present invention, and a flexible pipe connector according to the other embodiment of the present invention will be described hereinafter with reference to FIG. 10. Since an essential configuration of the invention among configurations that are not described hereinafter is the same as the embodiment of the present invention described above, description thereof will be omitted.

Referring to FIG. 10, in another embodiment of the present invention, a connection ring 60 for connecting a pipe is connected to the end of an end ring 20, and the step portions 65 and 25 are coupled so that an end portion of the connection ring 60 is connected to an end portion of the end ring 20.

The connection ring 60 may be made of the same material as the pipe connected to the flexible pipe connector, such as Cu.

Since other components not described above are the same as those in the embodiments of the present invention illustrated in FIGS. 6 to 9, further description thereof will be omitted.

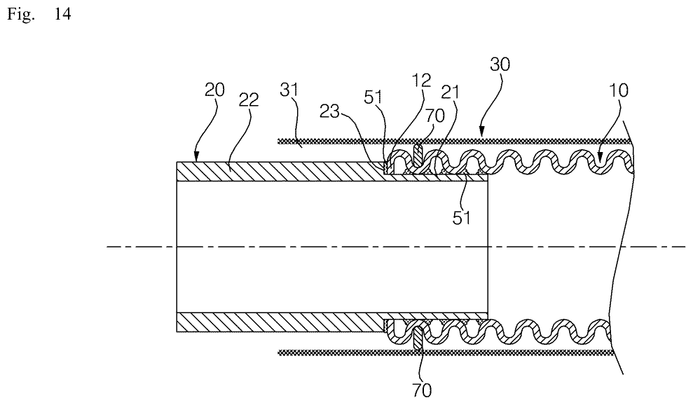

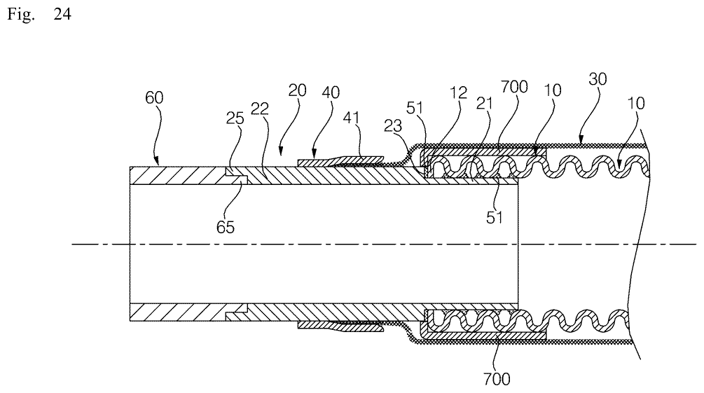

Hereinafter, a flexible pipe connector according to a third embodiment of the present disclosure will be described with reference to FIGS. 11 to 16. Referring to FIGS. 11 and 24, a flexible pipe connector according to an embodiment of the present disclosure includes a corrugated pipe 10 in which a plurality of crests and roots are formed alternately, an end ring 20 coupled to at least one of both end portions of the corrugated pipe 10, protective ring 70 or 700 disposed in the end portion of the corrugated pipe, a braided mesh 30 covering an outer circumferential surface of the corrugated pipe 10, the protective ring 70 or 700, and a portion of the outer circumferential surface of the end ring 20, and a welding ring 40 inserted into the end ring 20 to cover a portion of the outer circumferential surface of the end ring 20 and an end portion of the braided mesh.

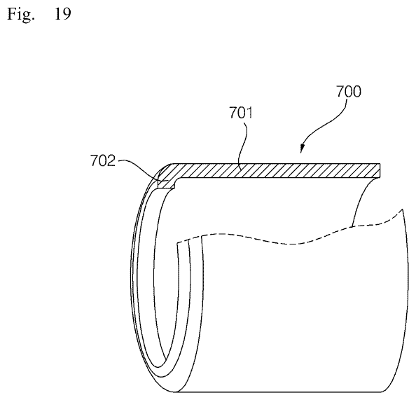

The protective ring 70 or 700 may include a circular ring 70 or a plate-shaped ring 700. The flexible pipe connectors according to the third embodiment illustrated in FIGS. 11 to 16, the fourth embodiment illustrated in FIG. 17, and the fifth embodiment illustrated in FIG. 18 may include the circular ring 70, and the flexible pipe connectors according to the sixth embodiment illustrated in FIGS. 19 to 23 and a seventh embodiment illustrated in FIG. 24 may include the plate-shaped ring 700.

As in the above-described embodiment, the corrugated pipe 10 may be made of STS 304 and STS 316L, which belong to austenitic stainless steel. The STS 304 contains C at 0.08% or less, Si at 0.5˜0.75%, P at 0.035% or less, Ni at 8.00˜15.00%, and Cr at 17.00˜18.00%, and the STS 316L is a stainless steel containing C at 0.03% or less, Si at 0.5˜0.75%, P at 0.035% or less, S at 0.03% or less, Ni at 12.00˜15.00%, Cr at 17.00˜18.00%, and Mo at 2.00˜3.00%, and a temperature range of solution heat treatment for stress relief of the STS 304 and STS 316L is 1065° C.˜1120° C.

Meanwhile, a corrugated pipe of the related art has a Vickers hardness (HV) of 200 or higher when a heat treatment process is not performed in a manufacturing process, and have a Vickers hardness (HV) of 160 to 170 when the heat treatment process is performed in the manufacturing process. It is preferable that the corrugated pipe of the present disclosure be made of a material having a Vickers hardness (HV) of 175 to 185 by adjusting a cooling temperature and cooling speed in the heat treatment process. This heat treatment scheme for the corrugated pipe has a double effect of eliminating welding stress and processing stress generated in a corrugated pipe manufacturing process and increasing spring elasticity.

The braided net 30, the end ring 20, the circular ring 70, and the welding ring 40 may also be made of the same material as the corrugated pipe 10.

Further, the corrugated pipe 10 may be manufactured so that a vertical extension portion 12 is formed to extend in a crest (upper) direction from the root of the corrugated pipe 10 located at an extreme end in the end portion of the corrugated pipe 10 or extend in a root (lower) direction from the crest of the corrugated pipe 10 located at the extreme end.

Since the end ring 20 of the present embodiment is the same as the end ring 20 of the embodiment described above with reference to FIGS. 2 and 3, description thereof will be omitted.

Referring to FIG. 12, the circular ring 70 may be formed in a ring shape as a whole, and may be formed to have an outer diameter larger than the crest of the corrugated pipe.

The circular ring 70 may be formed in an oval shape so that its cross section matches a shape of the root of the corrugated pipe, or, alternatively, may be formed in a circular shape.

The circular ring 70 may be formed in a size such that the circular ring 70 protrudes outward beyond the crest when the circular ring is inserted into the root of the corrugated pipe.

For example, the circular ring 70 may have an outer diameter 1 to 2 mm larger than the crest of the corrugated pipe, so that the circular ring 70 can protrude 0.5 to 1.0 mm outward beyond the crest of the corrugated pipe.

The circular ring 70 may be formed as a spring ring with one cut side 71. The circular ring 70 may be made of a metal or synthetic resin.

Since the welding ring 40 of the present embodiment is the same as the welding ring 40 of the embodiment described above with reference to FIGS. 4 and 5, description thereof will be omitted.

A method for manufacturing the flexible pipe connector according to the third embodiment of the present disclosure configured as described above will be described with reference to FIG. 6 and FIGS. 13 to 16.

As illustrated in FIG. 6, the step portion 21 formed to have a smaller outer diameter than the other side portion 22 of the end ring 20 is forcibly inserted into the end portion of the corrugated pipe 10, so that the vertical extension portion 12 located at the end of the corrugated pipe 10 is adjacent to the shoulder portion 23 of the end ring 20.

In the above, a paste welding agent 51 is applied to an inner circumferential surface in the end portion 11 of the corrugated pipe 10 and the vertical extension portion 12 so thin the end portion 11 of the corrugated pipe 10, the vertical extension portion 12, and the step portion 21 and the shoulder portion 23 of the end ring 20 can be welded later, and then the step portion 21 of the end ring 20 is forcibly inserted into the end portion of the corrugated pipe 10.

Therefore, since the vertical extension portion 12 formed at the end of the corrugated pipe 10 and the shoulder portion 23 of the end ring 20 are welded in a state in which the vertical extension portion 12 is engaged with the shoulder portion 23 of the end ring 20, the end ring 20 and the corrugated pipe 10 remain securely coupled without any loosening even when vibration or shock occurs during a long time.

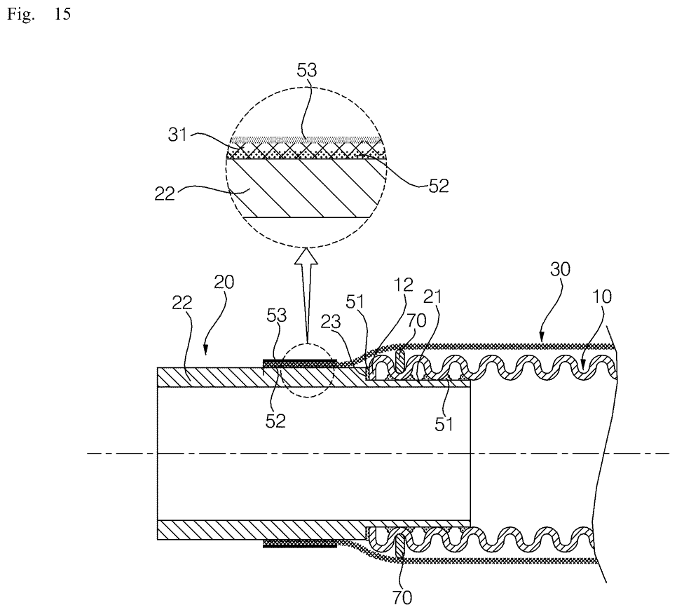

Next, as illustrated in FIG. 13, the circular ring 70 is disposed to be inserted into the root 13 at an extreme end between the crest 11a formed at the extreme end on one side of the corrugated pipe 10 and the crest 11b most adjacent to the crest 11a at an extreme end.

The circular ring 70 is formed as a spring ring with one cut side 71, so that the circular ring 70 can be inserted into the root 13 while returning to a circular shape due to elasticity, by the circular ring 70 being forcibly expanded and then disposed in the root 13.

In the above, the circular ring 70 may be formed of an elastic material in a closed circular shape without one cut side, and inserted into the root.

In the above, the circular ring may be disposed between the crest 11b formed at the extreme end of the corrugated pipe and the welding ring 20 to be described later instead of being inserted into the root 13, even though not shown here. In this case, a root (not shown) may be formed in the vertical extension portion 12 or a groove (not shown) may be formed between the vertical extension portion 12 and the end ring 20, and a portion of the circular ring may be inserted into the root or groove and supported.

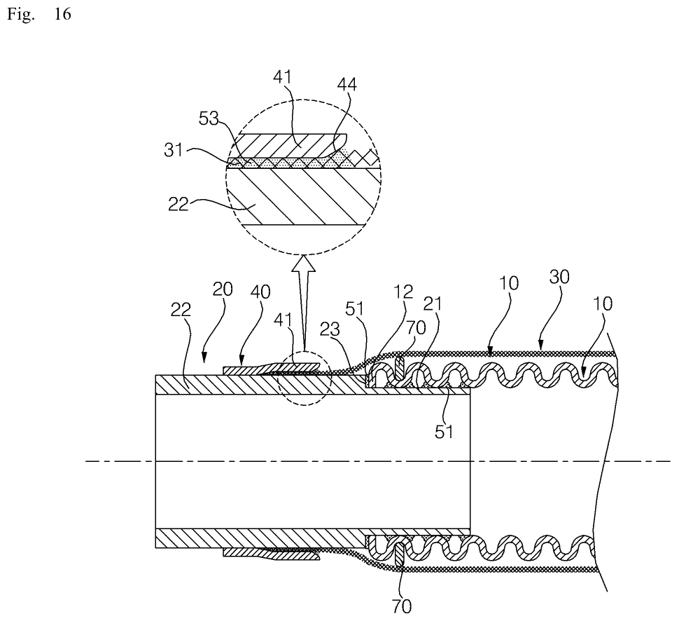

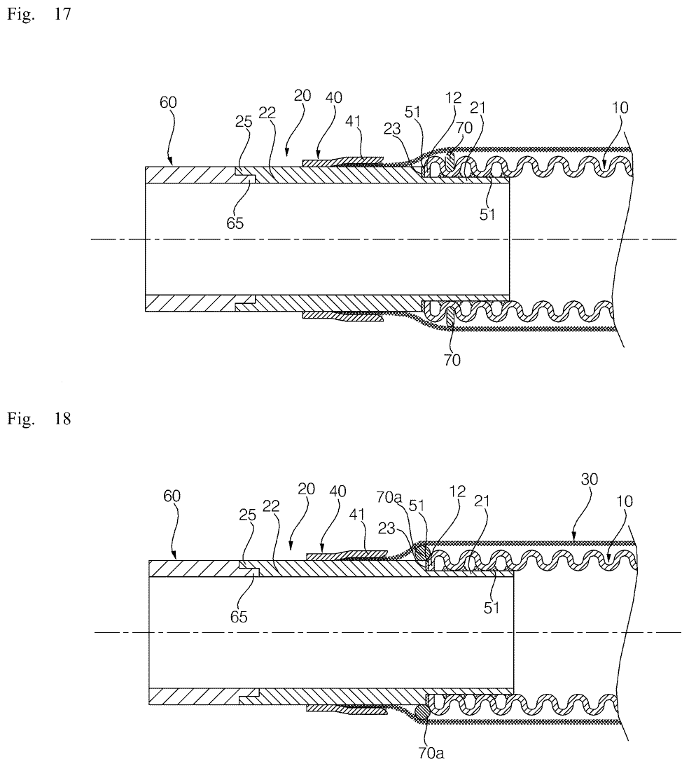

Then, as illustrated in FIG. 14, the outer circumferential surfaces of the corrugated pipe 10 and the circular ring 70 is covered with the braided net 30 so thin the end portion 31 of the braided net 30 is disposed on the outer circumferential surface of the other side portion 22 of the end ring 20, and as illustrated in FIG. 15, the end portion 31 of the braided net 30 is bonded to the outer circumferential surface of the end ring 20 using the instant adhesive 52 for a metal, and a paste welding agent 53 is applied to the end portion of the braided net 30.

Next, as illustrated in FIG. 16, the welding ring 40 is forcibly inserted into the other side portion 22 of the end ring 20, so that the end portion 31 of the braided net 30 is disposed in a gap formed between the inner circumferential surface of the expanded pipe portion 41 of the welding ring 40 and the outer circumferential surface of the end ring 20.

In the above, since the end portion 31 of the braided net 30 is bonded to the end ring 20 using an instant adhesive before the welding ring 40 is inserted into the end ring 20, the end portion of the braided net 30, particularly the fine steel wire of the braided net located at the end is bonded to the end ring 20 without bulging, so that the front end portion of the welding ring 40 can be easily inserted to a predetermined position of the end ring 20 without being caught by the steel wires of the braided net 30, and since an inner circumferential surface at the front end portion of the welding ring 40 is formed as an inclined surface 44, the end portion of the braided net 30 can be smoothly moved to a predetermined position of the welding ring 40.

Further, since inner circumferential surface at the front end portion of the welding ring 40 is formed as an inclined surface until the front end portion is inserted into the expanded pipe portion 41 of the welding ring 40, the end portion of the braided net 30 does not come into linear contact with the front end portion of the welding ring 40 but comes into oblique contact with the front end portion even when vibration or shock occurs for a long time, thereby preventing the end portion of the braided net from being damaged or cut.

As described above, when the corrugated pipe 10, the end ring 20, the circular ring 70, the braided net 30, and the welding ring 40 are placed and heated in a heat treatment furnace and then cooled in a state in which the corrugated pipe 10, the end ring 20, the circular ring 70, the braided net 30, and the welding ring 40 are coupled and coated with the welding agent, the welding agent applied to the end portion of the corrugated pipe 10 and the end portion of the braided net 30 is melted and then solidified, so that the corrugated pipe 10, the braided net 30, the end ring 20, and the welding ring 40 are securely welded together and integrated.

As the paste welding agent 51 or 53, an Ag—Mn-based welding agent having a welding temperature of 970° C. to 1150° C., an Ag—Cu-based welding agent having a welding temperature of 990° C. to 1090° C., or a Ni˜Cr-based welding agent having a welding temperature of 1090° C. to 1180° C., particularly a BNiCr-based welding agent containing Ni at 65 to 75 wt %, Cr at 13 to 20 wt %, B at 2.75 to 4.75 wt %, and trace amounts of Fe, Si, and C may be used.

Therefore, when the flexible pipe connector coupled as in FIG. 16 is placed in the heat treatment furnace and heated for about a few minutes at a temperature of 1050° C. to 1150° C., which is a melting temperature of the welding agent 51 or 53, the welding agent 51 or 53 is melted to permeate into a welded portion so that welding is performed, stress and processing hardening (working stress) generated during the molding of the corrugated pipe 10 are removed, the instant adhesive disappears, and when this is cooled, the welding of each component and the removal of the processing hardening of the corrugated pipe are completed at the same time, thereby completing the manufacture of the flexible pipe connector according to the present disclosure.

As described above, in the flexible pipe connector according to the present disclosure, the components can be easily and closely coupled to each other, there is no concern that the components will loosen or be damaged due to vibration, and the flexible pipe connector can be easily and quickly manufactured due to simultaneous execution of the welding process and the heat treatment process through a single heating process in the heat treatment furnace.

In particular, in the flexible pipe connector according to the third embodiment of the present disclosure, since the circular ring protruding beyond the corrugated pipe is disposed between the end portion of the corrugated pipe and the braided mesh, friction between an outer diameter portion (a top portion of the crest) of the corrugated pipe and the braided mesh is reduced and damage to the corrugated pipe is prevented even when vibration occurs, thereby improving the reliability and lifespan of a product.

FIG. 17 is a cross-sectional view illustrating the fourth embodiment of the present disclosure. Hereinafter, the flexible pipe connector according to the fourth embodiment of the present disclosure will be described with reference to FIG. 17. Among configurations that are not described below, essential configurations for configuring the invention are the same as those in the above-described embodiments, and thus description thereof will be omitted.

Referring to FIG. 17, in the fourth embodiment of the present disclosure, a connection ring 60 for connecting a pipe is connected to the end of an end ring 20, and the step portions 65 and 25 are securely coupled so that an end portion of the connection ring 60 is connected to an end portion of the end ring 20.

The connection ring 60 may be made of the same material as the pipe connected to the flexible pipe connector, such as Cu.

FIG. 18 is a cross-sectional view illustrating the fifth embodiment of the present disclosure. Hereinafter, a flexible pipe connector according to the fifth embodiment of the present disclosure will be described with reference to FIG. 18. The flexible pipe connector according to the fifth embodiment may be different from that according to the fourth embodiment described above in a position of the circular ring 70a. Descriptions of the same configurations and features as those in the fourth embodiment will be omitted.

Referring to FIG. 18, the circular ring 70a is disposed between the crest 11a at the extreme end formed on one side of the corrugated pipe and the welding ring 40. More specifically, the circular ring 70a is disposed to be in contact with a surface of the crest 11a at the extreme end facing the welding ring 40.

Here, although not shown, the circular ring may be disposed between the crest 11a at the extreme end and the welding ring 40, but may be disposed to be spaced apart from the crest 11a at the extreme end.

In the embodiment of FIG. 18, the circular ring 70a may have an outer diameter smaller than or equal to the crest of the corrugated pipe, and a closed circular ring may be used.

Meanwhile, as described above, for the protective rings 70 or 700, the plate-shaped ring 700 may be used instead of the circular ring 70 of the embodiment described above.

Hereinafter, the flexible pipe connector according to the sixth embodiment including the plate-shaped ring 700 will be described with reference to FIGS. 19 to 24. In order to help understanding of the present embodiment, the same components as in the above-described embodiment are denoted by the same reference numerals, and description thereof will be partially omitted.

Referring to FIG. 19, the plate-shaped ring 700 may be formed in an overall cylindrical shape and may be formed to have an outer diameter larger than that of the crest of the corrugated pipe 10.

The plate-shaped ring 700 may include a cylindrical body 701 and an engaging portion 702 that extends radially inward from one end of the body 701 and has a ring shape.

The plate-shaped ring 700 may have a thickness within a range of 0.2 to 0.4 mm. For example, the thickness of the plate-shaped ring 700 may be 0.3 mm.

The plate-shaped ring 700 may be formed to have an inner diameter equal to or 1 to 2 mm or larger than the crest of the corrugated pipe so that the corrugated pipe 10 may be inserted into the plate-shaped ring 700.

Therefore, the plate-shaped ring 70 may have an outer diameter larger than that of the crest of the corrugated pipe.

The plate-shaped ring 700 may be made of a metal or synthetic resin.

A method for manufacturing a flexible pipe connector including the plate-shaped ring 700 will be described with reference to FIG. 6 and FIGS. 20 to 23. Description of the same configuration as the method for manufacturing a flexible pipe connector of the third embodiment described above with reference to FIG. 6 and FIGS. 13 to 16 may be partially omitted.

Referring to FIG. 6, in the manufacturing method of the present embodiment, the corrugated pipe 10 and the end ring 20 are combined, as described above.

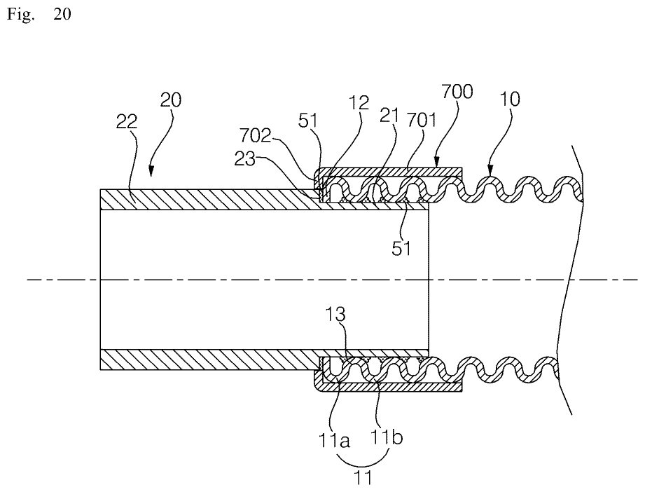

Then, the plate-shaped ring 700 is positioned on the outer side of the end ring 20 so that the end ring 20 is inserted into the plate-shaped ring 700, as illustrated in FIG. 20.

The other side portion 22 of the end ring 20 is inserted into the engaging portion 702 of the plate-shaped ring 700. The plate-shaped ring 700 is slid toward the corrugated pipe 10 so thin the end portion 11 of the corrugated pipe 10 is inserted into the body 701 of the plate-shaped ring 700. The plate-shaped ring 700 is slid so that the engaging portion 702 comes into contact with the end portion 11 of the corrugated pipe 10.

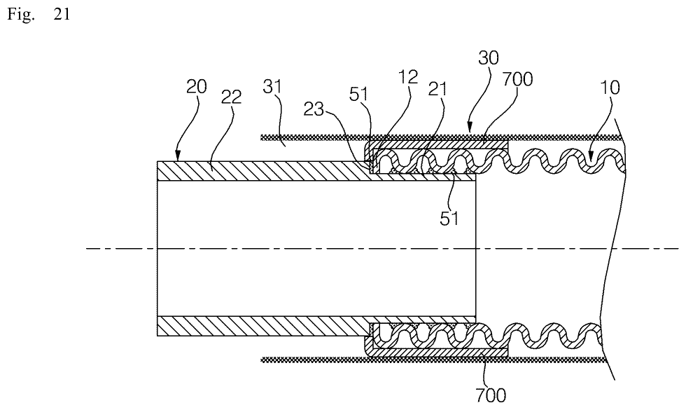

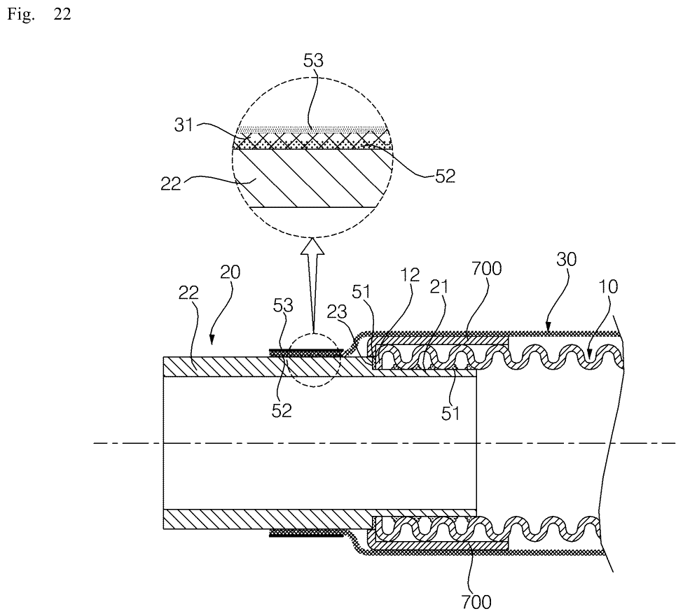

Then, the braided net 30 and the end ring 20 are disposed and bonded, and a paste welding agent 53 is applied to the end portion of the braided net 30, as described with reference to FIGS. 14 and 15, and as illustrated in FIGS. 21 and 22.

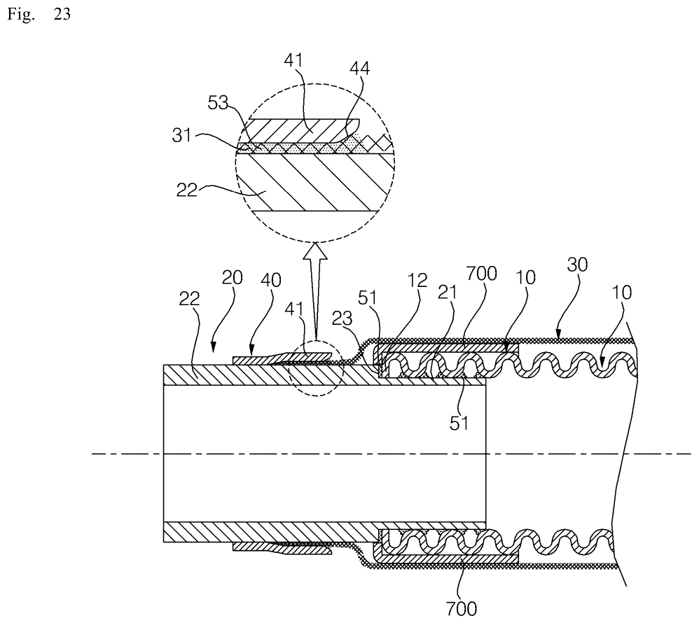

Then, the welding ring 40 is inserted into the end ring 20, as illustrated in FIG. 23 and described with reference to FIG. 16.

As described above, when the corrugated pipe 10, the end ring 20, the circular ring 70, the braided net 30, and the welding ring 40 are placed and heated in a heat treatment furnace and then cooled in a state in which the corrugated pipe 10, the end ring 20, the circular ring 70, the braided net 30, and the welding ring 40 are coupled and coated with the welding agent, the welding agent applied to the end portion of the corrugated pipe 10 and the end portion of the braided net 30 is melted and then solidified, so that the corrugated pipe 10, the braided net 30, the end ring 20, and the welding ring 40 are securely welded together and integrated.

When the flexible pipe connector coupled as in FIG. 23 is placed in the heat treatment furnace and heated for about a few minutes at a temperature of 1050° C. to 1150° C., which is a melting temperature of the welding agent 51 or 53, the welding agent 51 or 53 is melted to permeate into a welded portion so that welding is performed, stress and processing hardening (working stress) generated during the molding of the corrugated pipe 10 are removed, the instant adhesive disappears, and when this is cooled, the welding of each component and the removal of the processing hardening of the corrugated pipe are completed at the same time, thereby completing the manufacture of the flexible pipe connector according to the present disclosure.

In particular, in the flexible pipe connector according to the present embodiment, since the plate-shaped ring is disposed between the corrugated pipe and the braided mesh, friction between an outer diameter portion (a top portion of the crest) of the corrugated pipe and the braided mesh is reduced and damage to the corrugated pipe is prevented even when vibration occurs, thereby improving the reliability and lifespan of a product.

Hereinafter, a flexible pipe connector according to the seventh embodiment of the present disclosure will be described with reference to FIG. 24. Among configurations that are not described below, essential configurations for configuring the invention are the same as those in the above-described embodiments, and thus description thereof will be omitted.

Referring to FIG. 24, in the seventh embodiment of the present disclosure, a connection ring 60 for connecting a pipe is connected to the end of an end ring 20, and the step portions 65 and 25 are securely coupled so that an end portion of the connection ring 60 is connected to an end portion of the end ring 20.

The connection ring 60 may be made of the same material as the pipe connected to the flexible pipe connector, such as Cu.

It will be understood by those skilled in the art to which the present invention belongs that the present invention can be implemented in other specific forms without changing its technical idea or essential characteristics. Therefore, the embodiments described above should be understood as being illustrative in all respects and not restrictive. The scope of the present invention is indicated by the claims to be described below rather than the detailed description, and all changes or variations derived from the meaning and scope of the claims and their equivalent concept should be construed as being included in the scope of the present invention.

### DESCRIPTION OF SYMBOLS

10: Corrugated pipe 20: End ring
21: Step portion 23: Shoulder portion
30: Braided net 40: Welding ring
41: Expanded pipe portion 44: Inclined surface
51, 53: Welding agent 52: Adhesive
60: Connection ring 70: Circular ring
700: Plate-shaped ring

What is claimed is:

1. A flexible pipe connector comprising:
a corrugated pipe having a plurality of alternately formed crests and roots;
an end ring having one side portion inserted into and welded to an end portion of the corrugated pipe;
a protective ring disposed on an outer side of the end portion of the corrugated pipe;
a braided mesh configured to cover a portion of an outer circumferential surface of the end ring, an outer circumferential surface of the corrugated pipe, and an outer circumferential surface of the circular ring; and
a welding ring inserted into an outer side of the end ring, an end portion of the braided mesh being inserted into a gap formed between the welding ring and the end ring and welded.

2. The flexible pipe connector of claim 1, wherein the protective ring includes a circular ring inserted into a root formed in the end portion of the corrugated pipe.

3. The flexible pipe connector of claim 2, wherein the circular ring is inserted into a root formed at an extreme end in the root formed in the end portion of the corrugated pipe.

4. The flexible pipe connector of claim 2, wherein the circular ring is formed as a spring ring with at least one cut end.

5. The flexible pipe connector of claim 2, wherein the circular ring protrudes outward from the corrugated pipe beyond the crest of the corrugated pipe.

6. The flexible pipe connector of claim 5, wherein the circular ring has an outer diameter 1.0 mm to 2.0 mm larger than that of the crest of the corrugated pipe.

7. The flexible pipe connector of claim 1, wherein the protective ring includes a plate-shaped ring disposed on the outer side of the end portion of the corrugated pipe.

8. The flexible pipe connector of claim 7, wherein the plate-shaped ring includes
a body disposed on the outer side of the corrugated pipe; and
an engaging portion bent radially inward from an end portion of the body and being in contact with the end portion of the corrugated pipe.

9. The flexible pipe connector of claim 1, wherein the welding ring has an expanded pipe portion formed in one side portion, and the end portion of the braided net is inserted into a gap between the expanded pipe portion and the end ring.

10. The flexible pipe connector of claim 9, wherein the end ring has a step portion formed in an one side portion having a smaller outer diameter than the other side portion, the step portion of the end ring and the end portion of the corrugated pipe are welded, a shoulder portion is formed between the other side portion of the end ring and the step portion, an vertical extension portion is formed at an extreme end in the end portion of the corrugated pipe, and the shoulder portion of the end ring and the vertical extension portion of the corrugated pipe are welded.

11. The flexible pipe connector of claim 9, wherein a front end portion of the expanded pipe portion of the welding ring is formed as an inclined surface of which a diameter of an inner circumferential surface decreases inward.

12. The flexible pipe connector of claim 11,
wherein the corrugated pipe, the end ring, the protective ring, the braided net, and the welding ring are made of austenitic stainless steel, and
the corrugated pipe and the end ring, and the welding ring and the braided net are welded with an Au—Mn-based, Ag—Cu-based, or Ni—Cr-based welding agent.

13. The flexible pipe connector of claim 1, wherein the corrugated pipe has a Vickers hardness of 175 to 185.

14. A method for manufacturing a flexible pipe connector, comprising:
applying a welding agent to an end portion of a corrugated pipe and inserting one side portion of an end ring into the end portion;
disposing a protective ring in the end portion of the corrugated pipe before or after the applying;
covering a portion of an outer circumferential surface of the end ring, the corrugated pipe, and the protective ring with a braided net, a welding agent being applied to an end portion of the braided net;
inserting a welding ring into the end ring so that an expanded pipe portion of the welding ring covers the end portion of the braided mesh; and
heating an assembly of the corrugated pipe, the circular ring, the end ring, the braided mesh, and the welding ring in a heat treatment furnace to melt the welding agent and then performing cooling.

15. The method for manufacturing a flexible pipe connector of claim 14, wherein the disposing of the protective ring includes inserting a circular ring into a root formed in the end portion of the corrugated pipe.

16. The method for manufacturing a flexible pipe connector of claim 14, wherein the disposing of the protective ring includes disposing a plate-shaped ring so that a body of the plate-shaped ring is disposed on the outer side of the corrugated pipe and an engaging portion bent radially inward from the body of the plate-shaped ring is in contact with the end portion of the corrugated pipe.

17. The method for manufacturing a flexible pipe connector of claim 14, wherein, in the end ring, a root portion in the end portion of the braided mesh is welded on an outer circumferential surface of a step portion having a smaller outer diameter than the other side portion, and a vertical extension portion located at an extreme end of the corrugated pipe is welded to a shoulder portion formed between the step portion and the other side portion.

18. The method for manufacturing a flexible pipe connector of claim 14, wherein the end portion of the braided mesh is bonded to an outer circumferential surface of the end ring with an instant adhesive for a metal before the welding ring is inserted into the end ring.

19. The method for manufacturing a flexible pipe connector of claim 15, wherein the flexible pipe connector is heated to 1050° C. to 1150° C. for a predetermined time in a heat treatment furnace and then cooled so that a welding process and a metal heat treatment process are performed simultaneously,

20. The method for manufacturing a flexible pipe connector of claim 15, wherein a front end portion of the welding ring is processed so that an inner circumferential surface is formed as an inclined surface whose inner diameter decreases inward.
